(19) United States
(12) Patent Application Publication
(10) Pub. No.: US 2004/0196257 A1
(43) Pub. Date: Oct. 7, 2004

(54) Rotary input device

(75) Inventors: Tadamitsu Sato, Fukushima-ken (JP); Masahiro Soma, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/817,519

(22) Filed: Apr. 2, 2004

(30) Foreign Application Priority Data
Apr. 7, 2003 (JP) 2003-102705

(51) Int. Cl. G09G 5/00

(52) U.S. Cl. 345/156

(57) ABSTRACT

A thin input device is disclosed that is capable of simultaneously inputting rotational information and switching information. If a part of the human body H is rotated around a plurality of operating portions capacitance C is generated between the human body H and the respective electrodes, which are opposite to the human body H, in sequence. Therefore, a variation of the capacitance C corresponding to the respective operating portions is detected so as to obtain information on the rotational operation. In addition, if the operating portions are simultaneously tapped, the capacitances C of the electrodes are varied in sequence. Thus, simultaneous contact with the operating portions can be detected by detecting the variation of capacitance C.

### BACKGROUND OF THE INVENTION

1. Field of the Invention

The present invention relates to a rotary input device, and more particularly, to an input device capable of inputting both rotational information and switching information.

2. Description of the Related Art

Input devices, such as jog controllers, are provided with manipulators (i.e., dials) for inputting operational information determined by a rotational position.

The manipulator is rotatably supported on a circuit board provided in an electronic device. For example, a rotary board having a resistance pattern and an electrode pattern is fixed to the manipulator, and the circuit board is provided with a plurality of sliders.

If the manipulator is rotated, each of the sliders slides on the resistor pattern and the electrode pattern to detect the direction of rotation and the speed of rotation of the manipulator.

Meanwhile, in an input device having a switching function, a rotating body is supported so as to freely move forward and backward in a direction perpendicular to the rotation. In addition, a switching member is provided on the lower portion of the manipulator, and the lower end of a rotating shaft of the manipulator is connected to an operating portion of the switching member. If pressing force is applied to the manipulator and then released, the operating portion moves forward and backward together with the manipulator, so that the switching member turns on and off.

[Patent Document 1]

Japanese Unexamined Patent Application Publication No. 10-294043

In a conventional input device having both rotating and switching functions, since the slider mechanically slides on the resistor pattern or electrode pattern, the lifespan of the contact portions is shortened. In other words, if the input device is used for a long time, the mechanical input device has an inherent problem in that friction generated between the respective patterns and the slider causes inaccuracies in the measurement of the direction of rotation or the speed of rotation.

In addition, since the manipulator moves forward and backward in a vertical direction and the switching member is provided at the lower portion of the manipulator, it is difficult to reduce the entire thickness of the input device.

### SUMMARY OF THE INVENTION

Accordingly, the present invention is designed to solve the above problems, and it is an object of the present invention to provide a thin input device capable of inputting both rotational information and switching information and of lengthening its mechanical lifespan.

To achieve this object, there is provided an input device comprising: a plurality of electrodes arranged in a circumferential direction at equal intervals and having a predetermined area; an insulating sheet laminated on surfaces of the respective electrodes; and capacitance detecting means for detecting a variation of capacitance from the respective electrodes when the human body is adjacent to or in contact with the external surface of the insulating sheet.

The capacitance detecting means comprises clock signal generating means for generating a clock signal; delay means for delaying the clock signal according to the capacitance detected from the electrode when the human body is adjacent to or in contact with the external surface of the insulating sheet; smoothing means for generating a signal according to the delayed amount, based on the clock signal which does not pass through the delay means; and A/D converting means for analog-to-digital converting the signal according to the amount of the variation of capacitance.

The delay means, the smoothing means, and the A/D converting means are provided in each of the plurality of electrodes, respectively.

According to the input device of the present invention, it is possible to simultaneously obtain rotational information and switching information on the operating portions (the electrodes). In particular, since a portion of the human body is used as an electrode to detect a variation of capacitance, it is possible to make the entire thickness of the input device thinner.

In addition, according to the input device of the present invention, the capacitance detecting means detects a variation of the facing area between an electrode and the human body. The capacitance detecting means detects the time when the electrode faces the human body. Furthermore, the capacitance detecting means detects switching information on the plurality of electrodes simultaneously tapped.

Preferably, portions of the surface of the insulating sheet that are opposite to the electrodes are concaved or convexed from the surface of the insulating sheet. Alternatively, the entire operation region in which the plurality of electrodes is formed may be concaved or convexed from regions other than the operation region.

According to the above construction, since a user can use the convex or concave portions as guides, it is possible to improve the manipulation of the input device.

Preferably, marks for indicating positions of the respective electrodes are printed on the surface of the insulating sheet.

The marks can be used as signals to guide the user's eye.

In addition, preferably, a region in which the plurality of electrodes is formed is provided with a rotating body rotating around the center thereof.

According to the above construction, since the user can mechanically operate the rotating body, they can have a sensation (an operating sense or reliability according to the operation) of physically manipulating the input device.

### BRIEF DESCRIPTION OF THE DRAWINGS

FIG. 1 is a view illustrating an input device according to a first embodiment of the present invention, in which FIG. 1A is a perspective view of the input device, FIG. 1B is a cross-sectional view taken along the line a-a showing a cross-sectional configuration of the input device, and FIG. 1C is a cross-sectional view taken along the line a-a showing an another cross-sectional configuration of the input device;

FIG. 2 is a schematic diagram illustrating capacitance detecting means of the input device;

FIG. 3 is a view depicting signals detected at the respective parts of the capacitance detecting means shown in FIG. 2, in which FIG. 3A is a view showing a clock signal input to one input side of an AND circuit, FIG. 3B is a view showing a signal input from signal delay means to the other input side of the AND circuit, FIG. 3C is a view showing an output signal from the AND circuit, and FIG. 3D is a view showing an output signal from smoothing means;

FIG. 4 is a view illustrating an input device according to a second embodiment of the present invention, in which FIG. 4A is a perspective view of the input device, and FIG. 4B is a cross-sectional view taken along the line b-b of the input device shown in FIG. 4A; and

FIG. 5 is a view illustrating an input device according to a third embodiment of the present invention, in which FIG. 5A is a perspective view of the input device, and FIG. 5B is a cross-sectional view taken along the line c-c of the input device shown in FIG. 5A.

### DESCRIPTION OF THE PREFERRED EMBODIMENT

Preferred embodiments of the present invention will now be described with reference to the accompanying drawings.

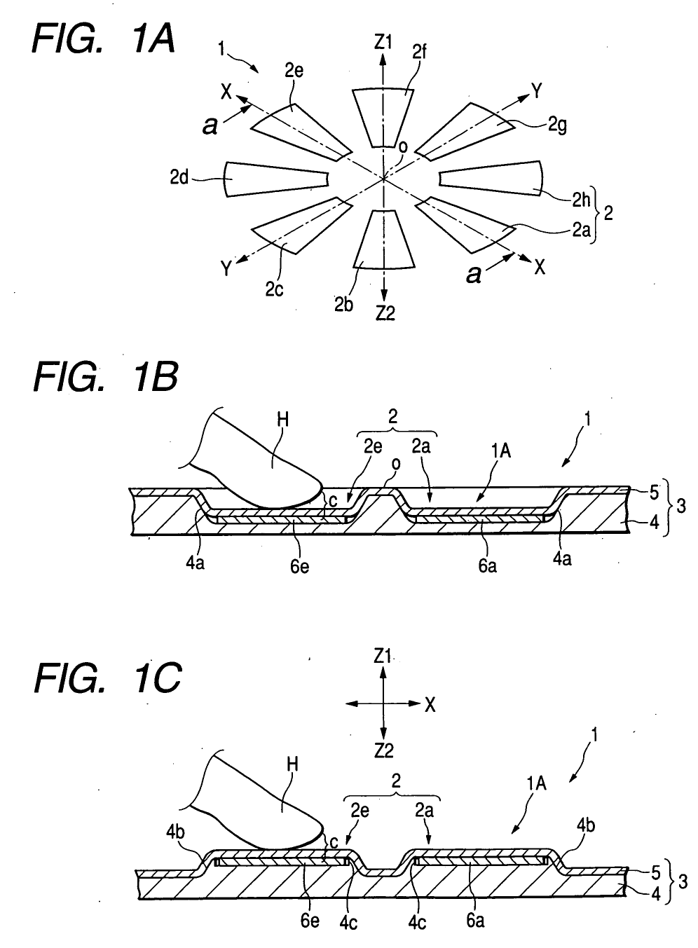

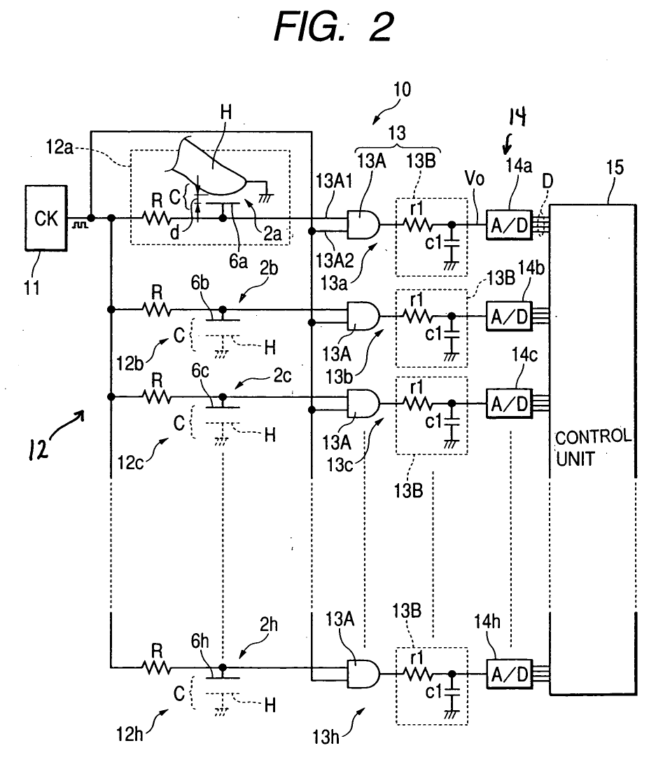

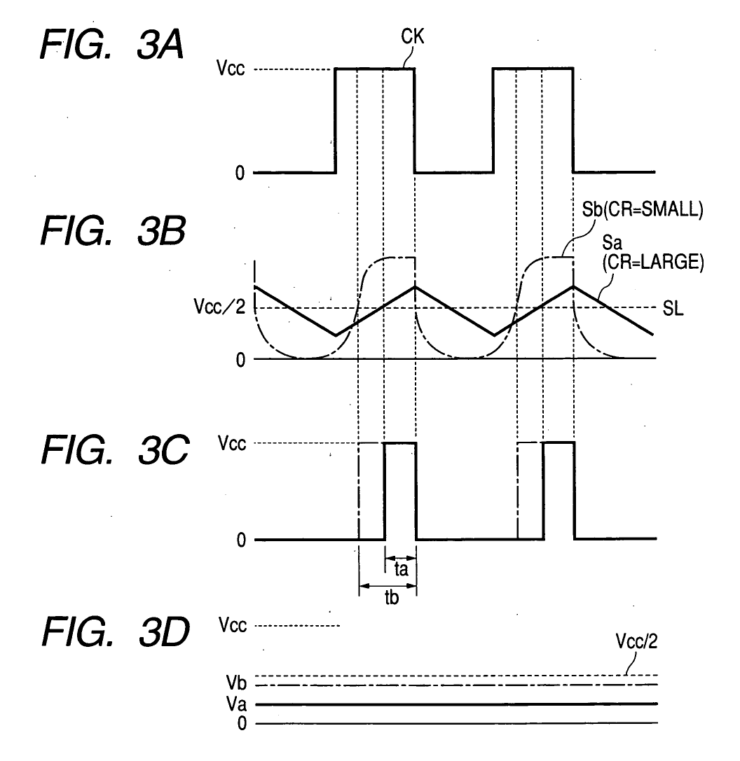

FIG. 1 is a view illustrating a first embodiment of the present invention, in which FIG. 1A is a perspective view of an input device, FIG. 1B is a cross-sectional view taken along the line a-a showing a cross-sectional configuration of the input device, and FIG. 1C is a cross-sectional view taken along the line a-a showing an another cross-sectional configuration of the input device. FIG. 2 is a schematic diagram illustrating capacitance detecting means of the input device. FIG. 3 is a view depicting signals detected at the respective parts of the capacitance detecting means shown in FIG. 2, in which FIG. 3A is a view showing a clock signal inputted to one input side of an AND circuit, FIG. 3B is a view showing a signal inputted from signal delay means to the other input side of the AND circuit, FIG. 3C is a view showing an output signal from the AND circuit, and FIG. 3D is a view showing an output signal from smoothing means. In FIG. 3, a solid line indicates a case in which capacitance C is high, while a dotted line indicates a case in which the capacitance C is low.

An input device 1 shown in FIGS. 1A to 1C is provided in, for example, controllers for personal computers or game consoles, or in operating panels of other electronic apparatuses. The operation of the input device 1 may allow a cursor displayed on the screen of a monitor to move or to allow the volume displayed on the screen to be adjusted.

Reference numeral 3 shown in FIGS. 1A to 1C indicates an operating panel obtained by laminating an insulating sheet 5 on a surface of a housing 4 made of synthetic resin. On the operating panel 3, an orthogonal coordinates system of the X-axis and the Y-axis is virtually depicted, and an intersection point of the X-axis and Y-axis is the center O. Eight fan-shaped operating portions 2, generally indicated by reference numeral 2 (each indicated by 2a, 2b, 2c, 2d, 2f, 2g, and 2h), are provided around the center O such that they are disposed at the same angle (45° in FIG. 1A) in a circumferential direction and have the same area. A region in which the eight operating portions 2 are provided is an operation region 1A of the input device 1.

In the input device 1 shown in FIGS. 1A and 1B, concave portions 4a recessed in the Z2 direction are formed on the housing 4 corresponding to the eight operating positions 2. Electrodes 6 (each indicated by 6a, 6b, 6c, 6d, 6e, 6f, 6g, and 6h, however, FIG. 1B shows only two electrodes 6a and 6e), each having a constant area, are buried in the respective concave portions 4a corresponding to the eight operating portions 2a to 2h. A surface of each of the electrodes 6a to 6h in the respective concave portions 4a is covered with the insulating sheet 5, and the insulating sheet 5 is laminated in line with the shapes of the respective concave portions 4a, thereby forming the operation region 1A.

Meanwhile, the input device 1 shown in FIG. 1C is different from the input device 1 shown in FIG. 1B in that convex portions 4b protruding in the Z1 direction are formed at the respective eight operating positions on the housing 4. Concave portions 4c are formed in the Z2 direction in the respective convex portions 4b, and the electrodes 6 (each indicated by 6a, 6b, 6c, 6d, 6e, 6f, 6g, and 6h, however, FIG. 1C shows only two electrodes 6a and 6e), each having a constant area, are buried in the respective concave portions 4c. A surface of each of the electrodes 6a to 6h in the respective convex portions 4b is covered with the insulating sheet 5, and the insulating sheet 5 is laminated in line with the shapes of the respective convex portions 4b, thereby forming the operation region 1A.

In the input device 1 according to the first embodiment of the present invention, since the operating portions 2 are formed in a convex or concave shape, a user can move his/her fingers along the shape.

Specifically, the user can move his/her fingers along the respective operating portions 2 formed of the convex or concave shape to improve manipulation. Therefore, for example, a blind person or a person having bad sight can operate the personal computer or game console using the input device 1.

As shown in FIG. 2, each of the electrodes 6a to 6h provided in the respective operating portions 2 constitutes a part of a circuit shown in FIG. 2. If a portion of the human body H, such as a hand or a finger, is adjacent or in contact with the external surface of the insulating sheet 5 covering the respective electrodes 6a to 6h, capacitance C is formed between the human body H and the electrode 6 opposite to the human body H. In other words, according to the present invention, a portion of the human body H, such as a hand or a finger, functions as an electrode for forming the capacitance C in cooperation with the electrode 6. In addition, the capacitance C is variable depending upon the facing area S or the distance d between the electrode 6 and the human body H.

As shown in FIG. 2, the capacitance detecting means 10 for detecting a variation of the capacitance C includes, in the housing 4, clock signal generating means 11, signal delay means 12, delay signal detecting means 13, A/D converting means 14, and a control unit 15. In the embodiment, the signal delay means 12 (each indicated by 12a to 12h), the delay signal detecting means 13 (each indicated by 13a to 13h), and the A/D converting means 14 (each indicated by 14a to 14h) are provided corresponding to the electrodes 6 (or the operating portions 2).

The clock signal generating means 11 continuously generates a regular pulse signal composed of a predetermined frequency. The signal delay means 12 comprises resistors R connected between the capacitances C and the clock signal generating means 11. Also, the delay signal detecting means 13 includes AND circuits 13A and smoothing means 13B that is provided to the rear stage of the AND circuits and comprises resistors r1 and capacitors c1. A signal passing through the signal delay means 12 and a clock signal CK (a clock signal does not pass through the signal delay means 12) outputted from the clock signal generating means 11 are inputted to input sides 13A1 and 13A2 of each of the AND circuits 13A, respectively, and an output from each of the AND circuits 13A is inputted to the smoothing means 13B.

The A/D converting means 14 of 8 bits, for example, is connected to the rear stage of the smoothing means 13B of the delay signal detecting means 13. The A/D converting means 14 detects an output voltage Vo from the smoothing means 13B at a predetermined sampling period to output the detected voltage to the control unit 15 as a digital output D. The control unit 15 includes a CPU as a main component and monitors the value of the digital output D outputted from each of the A/D converting means 14a to 14h.

In the input device 1, if a portion of the human body H, such as a hand or a finger, is adjacent to or in contact with any one of the operating portions 2, the capacitance C is varied. The capacitance C is represented by the following general equation 1:

C=∈(S/d) [F] [Equation 1]

wherein, ∈ is a dielectric constant between the electrode 6 and the human body H, S is the facing area between the electrode 6 and the human body H, and d is the distance between the electrode 6 and the human body H. The dielectric constant ∈ is the sum of a dielectric constant of the insulating sheet 5 and a dielectric constant of the air.

The case will now be described in which a portion of the human body H, such as a hand or a finger, is adjacent to the operating portion 2a in a state in which the clock signal CK composed of a predetermined frequency of an amplitude voltage Vcc is outputted from the clock signal generating means 11 to the AND circuits 13A and the signal delay means 12, as shown in FIG. 3A.

As shown in the uppermost part of FIG. 2, if the human body H is adjacent to the operating portion 2a, the distance d between the human body H and the electrode 6a is shortened, and the facing area S is increased, thereby increasing the capacitance C between the human body H and the electrode 6a which can be obtained from the equation 1. Accordingly, since a time constant CR defined by the product of the resistor R and the capacitance C of the signal delay means 12 connected to the electrode 6a becomes higher, the output from the signal delay means 12 is to be a chopping wave signal Sa as represented by a solid line in FIG. 3B. Accordingly, the output (the logical product) from the AND circuit 13A becomes a pulse wave of a pulse width ta as represented by a solid line in FIG. 3C. In addition, a threshold value SL of the H level and the L level in the AND circuit 13A is Vcc/2.

Meanwhile, if the human body H is away from the operating portion 2a, the distance d between the human body H and the electrode 6a increases, and the facing area S decreases, thereby reducing the capacitance C between the human body H and the electrode 6a according to the equation 1. Accordingly, the time constant CR becomes smaller, and the output from the signal delay means 12 is to be a waveform Sb as represented by a one-dot chain line in FIG. 3B. Accordingly, the output (the logical product) from the AND circuit 13A becomes a pulse wave of a pulse width tb as represented by a one-dot chain line in FIG. 3C.

The pulse width ta when the capacitance C is small, and the pulse width tb when the capacitance C is high hold the relationship of ta<tb. For the output voltage Vo from the smoothing means 13B, the output voltage Vb in the case in which the human body H is away from the operating portion 2a (i.e., the capacitance C is small) is larger than the output voltage Va in the case in which the human body H is adjacent to or in contact with the operating portion 2a (i.e., the capacitance C is high), in other words, Va<Vb.

The output voltage Va or Vb from the smoothing means 13B is converted into the digital output D by the A/D converting means 14a corresponding to the operating portion 2a to output the converted voltage to the control unit 15. The control unit 15 monitors the digital output D to determine whether it exceeds a predetermined threshold value, thereby detecting whether the human body H is adjacent to or in contact with the operating portion 2a.

Accordingly, the control unit 15 monitors all digital outputs D from the A/D converting means 14a to 14h to detect whether the human body H is adjacent to or in contact with any one of the operating portions 2a to 2h.

In addition, the control unit 5 monitors the respective digital outputs D from the A/D converting means 14a to 14h at a given period to detect the direction or speed of motion of the human body H. Accordingly, in a case where the human body H is rotated around the center O in a direction from the operating portion 2a to the operating portion 2h, for example, in the order of the operating portion 2a→the operating portion 2b→the operation portion 2c→ . . . →the operating portion 2h→the operating portion 2a, the control unit 15 can detect the direction of rotation or the speed of rotation (i.e., the angular velocity) around the center O. Therefore, the input device can be used, for example, to move the cursor displayed on the screen of the monitor by using the operating information.

Furthermore, the control unit 15 can detect, for example, the time when the human body H comes into contact with the operating portions 2. If it is determined that the contacted time is shorter than a predetermined time, the control unit determines that the user has performed a tap or click operation, and it is possible to use the determined information as the operating information on the switch. Meanwhile, if it is determined that the contacted time is longer than a predetermined time, it is possible to use the determined information as the operating information for allowing the cursor to directly move.

Moreover, even when two or more fingers (the human body H) are simultaneously adjacent to or in contact with two or more operating portions 2, the control unit 15 can monitor the respective digital outputs D of the A/D converting means 14a to 14h to detect operating portions 2 to which the human body H is adjacent to or in contact with.

Accordingly, even when the user simultaneously performs a tapping operation on two or more operating portions 2 using the user's two or more fingers, the control unit 15 can detect the operational information on these switches. In other words, the input device 1 can detect the operational information (the information simultaneously inputted from multiple points) simultaneously inputted from the plurality of switches.

For example, in a case in which the input device 1 is provided in a controller of a game console, when the operating portion 2a and the operating portion 2c are simultaneously operated, the operational information thereon can allow a game character displayed on the screen of the monitor to behave in a specific way through game software.

As such, for an electronic device employing such an input device 1, the control unit 15 can process various operations by combining the operational information (the information simultaneously inputted from multiple points) input from the plurality of operating portions 2.

Another embodiment of the input device will now be described.

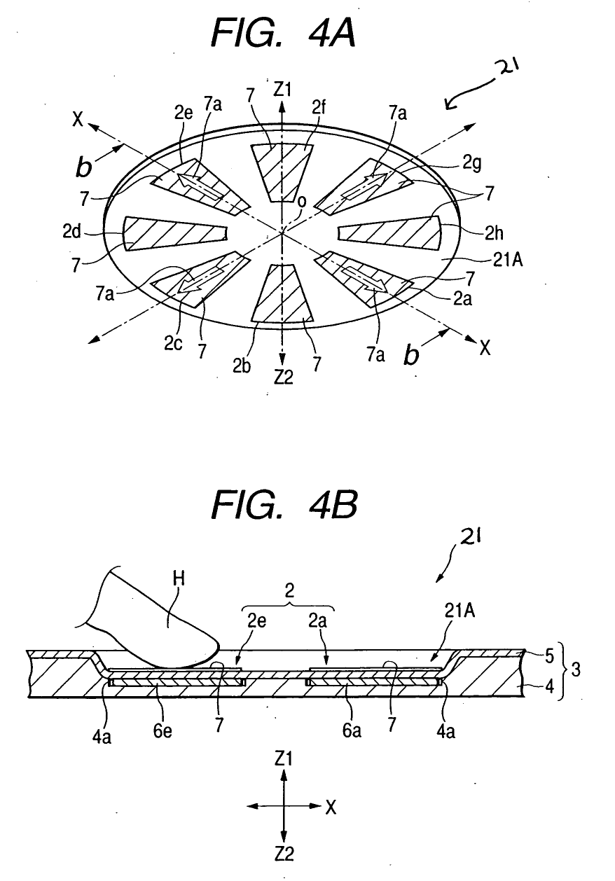

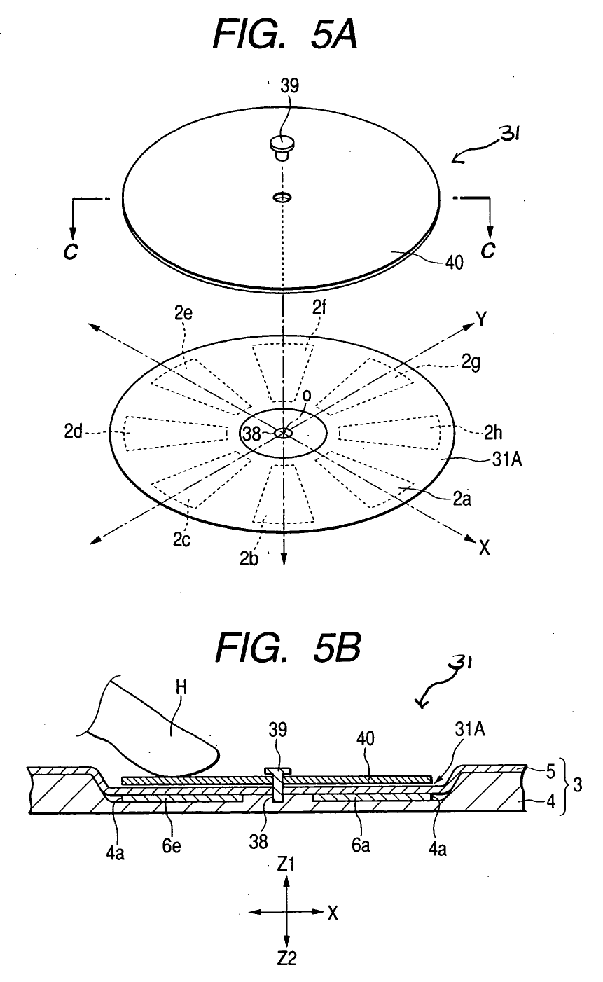

FIG. 4 is a view illustrating an input device according to a second embodiment of the present invention, in which FIG. 4A is a perspective view of the input device, and FIG. 4B is a cross-sectional view taken along the line b-b of the input device shown in FIG. 4A. FIG. 5 is a view illustrating an input device according to a third embodiment of the present invention, in which FIG. 5A is a perspective view of the input device, and FIG. 5B is a cross-sectional view taken along the line c-c of the input device shown in FIG. 5A.

In the second embodiment of the present invention shown in FIG. 4, the entire operation region 21A is recessed in the Z2 direction on an operating panel 3 provided with eight operating portions 2, generally indicated by reference numeral 2 (each indicated by 2a, 2b, 2c, 2d, 2e, 2f, 2g, and 2h), of an input device 21.

As shown in FIG. 4B, concave portions 4a recessed in the Z2 direction are formed in the operation region 21A so as to correspond to the eight operating portions 2, respectively. Electrodes 6 (each indicated by 6a, 6b, 6c, 6d, 6e, 6f, 6g, and 6h) are provided in the concave portions 4a, respectively. An insulating sheet 5A is stacked on the surfaces of the electrodes 6a to 6h in the concave portions 4a so as to cover the entire surface of the operation region 21A.

On the surface of the insulating sheet 5, fan-shaped marks 7 which have the same shape as the operating portion 2 are printed on the eight operating portions 2, respectively. The marks 7 respectively correspond to the operating portions 2 in a state in which the insulating sheet 5 is stacked on the operation region 21A. In other words, the marks 7 indicate the positions of the electrodes.

In addition, the marks 7 corresponding to the operating portions 2a and 2e disposed along the X-axis and the marks 7 corresponding to the operating portions 2c and 2g disposed along the Y-axis are printed by arrow marks 7a facing outwardly from the center O.

Further, according to the input device 21 of the second embodiment, since the mark 7 can be used as a sign, the user can easily recognize operational portions in the operation region 21A. Also, it is possible to move his/her finger in a correct direction using the arrow mark 7a as the sign.

Moreover, since the mark 7 is used as the sign, it seems that it is not necessary to recess the operation region 21A. However, if the operation region 21A is formed of concave portions, the user can use the edge of the operating portion as a guide. Therefore, the user's fingers can be smoothly moved, thereby improving the manipulation.

In addition, according to the input device 21 of the second embodiment of the present invention, if the human body H is adjacent to or in contact with the mark 7 provided on the insulating sheet 5, capacitance C is formed between the human body H and the electrode 6. Accordingly, it is possible to obtain operational information from the operating portions 2, as in the first embodiment.

An input device 31 according to a third embodiment of the present invention will now be described with reference to FIG. 5.

The input device 31 shown in FIG. 5 has a configuration substantially similar to that of the second embodiment. In other words, an operation region 31A is recessed in the Z2 direction on a portion of a housing 4, and eight concave portions 4a are formed in the operation region 31A. Electrodes, generally indicated by reference numeral 6 (each indicated by 6a, 6b, 6c, 6d, 6e, 6f, 6g, and 6h) are provided in the respective concave portions 4a. An insulating sheet 5 is stacked on the surfaces of electrodes 6 in the concave portions 4a, and the entire surface of the operation region 31A is covered with the insulating sheet 5. In addition, portions corresponding to the respective electrodes 6a to 6h are operating portions 2a to 2h.

However, the third embodiment is different from the first and second embodiment in that a rotating shaft 39 is fixed to a bearing portion 38 formed at the center O of the operation region 31A, and a rotary body 40 having a disc shape is rotatably supported on the rotating shaft 39.

The rotary body 40 has a thickness of 1 mm or less, and is formed of a relatively soft resin sheet, such as PET (Polyethylene Terephthalate).

Since the diameter of the rotary body 40 is smaller than that of the operation region 31A, the rotary body 40 can slide and rotate on the surface of the insulating sheet 5 in the operation region 31A. In addition, since the frictional resistance between the insulating sheet 5 and the rotary body 40 is low, the rotary body 40 can be smoothly rotated.

In the third embodiment, as shown in FIG. 5B, when a portion of the human body H, such as a finger, pushes and rotates the surface of the rotary body 40, the rotary body 40 turns together with the human body H. Accordingly, it is possible to prevent the human body H from leaving the operation region 31A while the user operates the rotary body 40. In addition, since a mechanically rotating member can be operated, the user is provided with a sensation (an operating sense or reliability according to the operation) of actually operating the input device 31. Accordingly, the maneuverability of the input device 31 is improved.

According to the input device 31 of the third embodiment, if the human body H is adjacent to or in contact with the surface of the rotary body 40, the capacitance C is formed between the human body H and the electrode 6, which is opposite to the human body H, through the rotary body 40 and the insulating sheet 5. Accordingly, as in the first and second embodiments, it is possible to obtain the operational information on the operating portion 2.

In addition, the third embodiment is provided with the rotary body 40 sliding mechanically. Since it is not necessary to obtain the rotating information on the rotary body 40 or the operational information of the switch, it is possible to obtain the operational information without being affected by the mechanical lifespan of the rotating body even when the rotary body 40 should not happen to be used due to friction.

The operation regions 21A and 31A of the second and third embodiments are not limited to the concave shapes as shown in FIGS. 4B and 5B, and they may have the convex shape as shown in FIG. 1C or a flat shape.

Furthermore, in the input device according to the first to third embodiments, the means for detecting the rotation and the means for detecting the operation of the switch are not formed of different members as compared with the conventional construction. In other words, it is possible to obtain the rotation information on the operating portions and the operational information on the switch using the same means. Thus, it is possible to reduce the number of components and thus to obtain a thin input device.

As described above, according to the present invention, it is possible to provide an input device capable of simultaneously inputting rotational information on the operating portion and operational information on the switch.

In addition, the input device can detect a variation in capacitance without being affected by the mechanical lifespan. Therefore, it is possible to semi-permanently prolong the lifespan of the input device.

Furthermore, since a portion of the human body is used as an electrode for detecting capacitance, it is possible to reduce the thickness of the input device.

1. An input device comprising:
a plurality of electrodes arranged in a circumferential direction at equal intervals and having a predetermined area;
an insulating sheet laminated on surfaces of the respective electrodes; and
capacitance detecting means for detecting a variation of capacitance from the respective electrodes when a human body is adjacent to or in contact with an external surface of the insulating sheet.

2. The input device according to claim 1, wherein the capacitance detecting means comprises: clock signal generating means for generating a clock signal;
delay means for delaying the clock signal according to the capacitance detected from the electrode when the human body is adjacent to or in contact with the external surface of the insulating sheet;
smoothing means for generating a smoothed signal according to a delayed amount, based on the clock signal which does not pass through the delay means; and
A/D converting means for analog-to-digital converting the smoothed signal according to an amount of the variation of capacitance.

3. The input device according to claim 2, wherein the delay means, the smoothing means, and the A/D converting means are provided in each of the plurality of electrodes, respectively.

4. The input device according to claim 1, wherein the capacitance detecting means detects a variation of a facing area between one of the electrodes and the human body.

5. The input device according to claim 1, wherein the capacitance detecting means detects a time when the electrode faces the human body.

6. The input device according to claim 1, wherein the capacitance detecting means detects switching information on the plurality of electrodes simultaneously tapped.

7. The input device according to claim 1, wherein portions of the surface of the insulating sheet that are opposite to the electrodes are concaved or convexed from the surface of the insulating sheet.

8. The input device according to claim 1, wherein an entire operation region in which the plurality of electrodes is provided is concaved or convexed from regions other than the operation region.

9. The input device according to claim 8, wherein marks for indicating positions of the respective electrodes are printed on the surface of the insulating sheet.

10. The input device according to claim 1, wherein a region in which the plurality of electrodes is formed is provided with a rotating body rotating around a center of thereof.
